(19) United States
(12) Patent Application Publication
(10) Pub. No.: US 2008/0273117 A1
(43) Pub. Date: Nov. 6, 2008

(54) DIGITAL CAMERA DEVICE AND METHOD FOR CONTROLLING THE OPERATION THEREOF

(75) Inventor: Rene NILSSON, Eslov (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/744,390

(22) Filed: May 4, 2007

(51) Int. Cl. H04N 11/00

(52) U.S. Cl. 348/552; 348/E11.001; 348/E11.002

(57) ABSTRACT

A digital camera device, a method and/or a computer program product for controlling the digital camera device. The digital camera device comprises an imaging device for sensing the image of a subject using an image sensor and outputting image data representing the image of the subject, and an imaging lens for forming the image of the subject on a photoreceptive surface of the image sensor. Furthermore, the digital camera includes a lens protector configured to cover the imaging lens, wherein the lens protector comprises a light-diffusing material for illuminating the image sensor when the lens protector covers the imaging lens. The digital camera device also includes a blemish position detector operative when the lens protector covers the imaging lens. When the image sensor is illuminated the blemish position detector is further configured to detect the position of blemish on an image, which is represented by image data output from the imaging device, on the basis of image data output from the imaging device.

### TECHNICAL FIELD

The present invention relates to the art of digital photography, and more particularly to digital camera devices such as digital still cameras, digital video cameras and digital camera devices incorporated in mobile telephones. More particularly, the present invention relates to a solution for detecting or identifying blemish, e.g. dust particles, on an image.

### BACKGROUND

Digital cameras have increased tremendously in popularity over the last decade, as high quality image sensor cameras have become affordable. Miniaturization of both optics and electronics has resulted in extremely compact camera modules, and it has therefore become a common approach to introduce digital cameras in mobile phones, commonly referred to as camera phones. Initially, still image cameras were employed, but also video recording cameras are commonly included in state of the art mobile phones today.

The imaging lens of digital cameras in camera phones is sometimes protected by a mechanically operated lens protecting device, commonly referred to as the lens protector. In the known prior art, the general purpose of the lens protector is to protect the imaging lens from dust and scratches. The lens protector is opened when the digital camera is used, whereas it is closed (and thus covers the imaging lens) when the camera is not used. When the lens protector is closed, the lens of the camera can thus be protected from scratches and the like.

In the known prior art, a digital still camera may obtain image data representing the image of a subject by sensing the image of the subject using a CCD-sensor (Charged-Coupled Device) and may further record the image data on a recording medium such as a memory card. If dust or the like attaches itself to the photoreceptive surface of the CCD, the image of the dust appears on the sensed image. Likewise, if dust appears on the lens of the digital camera, the image of the dust appears on the sensed image. Even further, though there are instances where an optical low-pass filter may be provided in front of the CCD, the image of any dust that has attached itself to the low-pass filter will also appear on the image obtained by the sensing. In fact, all dust anywhere in the optical path may result in that the dust appears in the sensed image.

Dust or the like appearing anywhere in the optical path of the digital camera cannot easily be removed from outside the digital camera. As a mere example, dust or the like on the imaging lens or dust on the photoreceptive surface of a CCD or dust on an optical low-pass filter cannot easily be removed from outside the digital camera. When the sensed image is printed, therefore, the image of the dust also shows up in the printed image. Accordingly, digital camera devices may have problems caused by dust particles in particular and blemish in general. Problems caused by dust are in general more severe the closer to the image sensor the dust appears.

Irrespective of how many protective measures that are taken for limiting the amount of e.g. dust particles, there will most probably always be at least some amount of such dust particles present in the optical path. Hence, a digital camera device and/or a method providing for detecting blemish, e.g. defects caused by dust particles, would be advantageous. Preferably, the digital camera device should also provide for image correction if blemish is detected or identified.

### SUMMARY OF THE INVENTION

An aspect of the invention relates to a digital camera device having an imaging device for sensing the image of a subject using an image sensor and outputting image data representing the image of the subject, and an imaging lens for forming the image of the subject on a photoreceptive surface of the image sensor, the digital camera comprising:
a lens protector configured to cover the imaging lens, wherein the lens protector comprises a light-diffusing material for illuminating the image sensor when the lens protector covers the imaging lens; and
a blemish position detector operative when the lens protector covers the imaging lens, and when the image sensor is illuminated the blemish position detector is further configured to detect the position of blemish on an image, which is represented by image data output from the imaging device, on the basis of image data output from the imaging device.

In one embodiment, the light-diffusing material is a translucent material.

In one embodiment, the lens protector comprises a surface with a coating made of the translucent material.

In one embodiment, the entire lens protector is made of the translucent material.

In one embodiment, the transmittance of the light-diffusing material is within the range of 10-90%.

In one embodiment, the light-diffusing material exhibits Lambertian reflectance of incident light.

In one embodiment, the light-diffusing material is glass.

In one embodiment, the glass is opal glass or ground glass.

In one embodiment, the light-diffusing material is plastics.

In one embodiment, the lens protector further comprises a light source operable to illuminate the lens protector, such that image sensor can be illuminated by the illuminated lens protector when the lens protector covers the imaging lens.

In one embodiment, the light source is a Light Emitting Diode positioned within the lens protector.

In one embodiment, the light source is an electroluminescent foil positioned within the lens protector.

In one embodiment, the lens protector comprises a light-guiding material, a light source operable to illuminate the light-guiding material, and a surface with a coating made of the light-diffusing material, wherein the coating of light-diffusing material is configured to diffusely reflect incident light when the light guiding material is illuminated and wherein said coating is further positioned such that the image sensor can be illuminated by the illuminated light-guiding material when the lens protector covers the imaging lens.

In one embodiment, the light-guiding material comprises polymethyl methacrylate (PMMA).

In one embodiment, the light-guiding material comprises polycarbonate (PC).

In one embodiment, said coating is made of an opaque material.

In one embodiment, said coating is a white paint.

In one embodiment, said coating comprises Barium Sulfate particles.

In one embodiment, the light source is a Light Emitting Diode positioned within the lens protector.

In one embodiment, the light source is an electroluminescent foil positioned within the lens protector.

In one embodiment, the digital camera device further comprises a light source operable to illuminate the lens protector, such that image sensor can be illuminated by the illuminated lens protector when the lens protector covers the imaging lens.

In one embodiment, the light source is a Light Emitting Diode positioned in proximity to the lens protector.

In one embodiment, the digital camera device further comprises
a storage device, configured to store the blemish position detected by said blemish position detector; and
a correction device operative when the lens protector covers the imaging lens, the correction device being configured to correct for the image of the blemish, at the position stored in said storing device.

In one embodiment, the blemish comprises dust particles.

In one embodiment, the digital camera device is incorporated in a mobile telephone.

Another aspect of the invention relates to a method of controlling the operation of a digital camera device having an imaging device for sensing the image of a subject using an image sensor and outputting image data representing the image of the subject, an imaging lens for forming the image of the subject on a photoreceptive surface of the image sensor, and a lens protector configured to cover the imaging lens, wherein the lens protector comprises a light-diffusing material for illuminating the image sensor when the lens protector covers the imaging lens, the method comprising the steps of:
operating the lens protector to cover the imaging lens; and
detecting the position of blemish on an image, which is represented by image data output from the imaging device, on the basis of image data output from the imaging device.

In one embodiment, the method further comprises the step of:
illuminating the lens protector, such that image sensor can be illuminated when the illuminated lens protector covers the imaging lens.

In one embodiment, the method further comprises the steps of:
storing the detected blemish position; and
correcting for the image of the blemish, at the stored position.

In one embodiment, the blemish comprises dust particles.

Still another aspect of the invention relates to a computer program product comprising computer program code means for controlling the operation of a digital camera device when said computer program code means is executed by means of a processor of the digital camera device, the digital camera having an imaging device for sensing the image of a subject using an image sensor and outputting image data representing the image of the subject, an imaging lens for forming the image of the subject on a photoreceptive surface of the image sensor, and a lens protector configured to cover the imaging lens, wherein the lens protector comprises a light-diffusing material for illuminating the image sensor when the lens protector covers the imaging lens; wherein the computer program code means comprises:

code means for operating the lens protector to cover the imaging lens; and

code means for detecting the position of blemish on an image, which is represented by image data output from the imaging device, on the basis of image data output from the imaging device.

In one embodiment, the computer program product further comprises code means for illuminating the lens protector, such that image sensor can be illuminated when the illuminated lens protector covers the imaging lens.

In one embodiment, the computer program product further comprises code means for storing the detected blemish position and code means for correcting for the image of the blemish, at the stored position.

In one embodiment, the computer program product is embodied on a computer readable medium.

In one embodiment, the digital camera device is incorporated in a mobile telephone.

Some embodiments of the invention provide for a quick, easy and cheap way of detecting blemish. The presented solution according to some embodiments of the invention are different from existing solutions in that they assume the use of a lens protector, which enables for a uniform illumination of the image sensor of the digital camera. This in turn may allow for the detection of blemish such as dust particles. Thus, the lens protector according to some embodiments of the invention fulfils a dual purpose in that it provides mechanical protection for the lens and also allows for the detection of blemish by enabling uniform illumination of the image sensor. A digital camera device according to some embodiments of the present invention may be particularly suitable if the camera device is already intended to include a lens protector for any other purpose, e.g. for mechanical protection of the lens of the camera device. It is an advantage with some embodiments of the invention that they allow an easy and quick way of blemish detection and correction which can be performed by the users of the camera devices themselves. To sum up, as compared with the known prior art some embodiments of the invention provide for an improved digital camera device and/or an improved method allowing for blemish detection.

### BRIEF DESCRIPTION OF THE DRAWINGS

Further objects, features and advantages of the invention will appear from the following detailed description of embodiments of the invention, wherein embodiments of the invention will be described in more detail with reference to the accompanying drawings, in which:

FIG. 1a schematically illustrates a front view of an embodiment of a camera device in the form of a camera phone;

FIG. 1b schematically illustrates a rear view of the camera device of FIG. 1a, where the read side includes a digital camera;

FIG. 1c schematically illustrates the rear view of the camera device of FIG. 1b, when the digital camera is mechanically protected by a lens protector;

FIG. 2a schematically illustrates a rear view of another embodiment of a camera device, where the read side includes a digital camera;

FIG. 2b schematically illustrates the rear view of the camera device of FIG. 2a, when the digital camera is mechanically protected by a lens protector;

FIG. 3a is a cross-sectional view of an embodiment of the camera phone illustrated in FIG. 1b;

FIG. 3b is a cross-sectional view of an embodiment of the camera phone illustrated in FIG. 1c;

FIG. 4a is a detailed cross-sectional view of an embodiment of the lens protector shown in FIGS. 3a and 3b.

FIG. 4b is a detailed cross-sectional view of another embodiment of the lens protector shown in FIGS. 3a and 3b.

FIG. 4c is a detailed cross-sectional view of yet another embodiment of the lens protector shown in FIGS. 3a and 3b.

FIG. 5 is block diagram illustrating a structure of an embodiment of an imaging section;

FIG. 6 is a block diagram illustrating the components of an embodiment of the camera device shown in FIGS. 1a, 1b, 1c, 3a, 3b and 4a.

FIG. 7 is a flowchart illustrating an embodiment of a method for detecting blemish artifacts on an image.

### DETAILED DESCRIPTION OF EMBODIMENTS

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The present description relates to the field of camera devices including digital cameras. A best mode of the invention known to date is to employ embodiments of the invention in a camera phone, i.e. a mobile phone being equipped with a digital camera. However, embodiments of the invention are as such equally applicable to digital camera devices which do not include radio communication capabilities. However, for the sake of clarity and simplicity, most embodiments outlined herein are related to mobile phones.

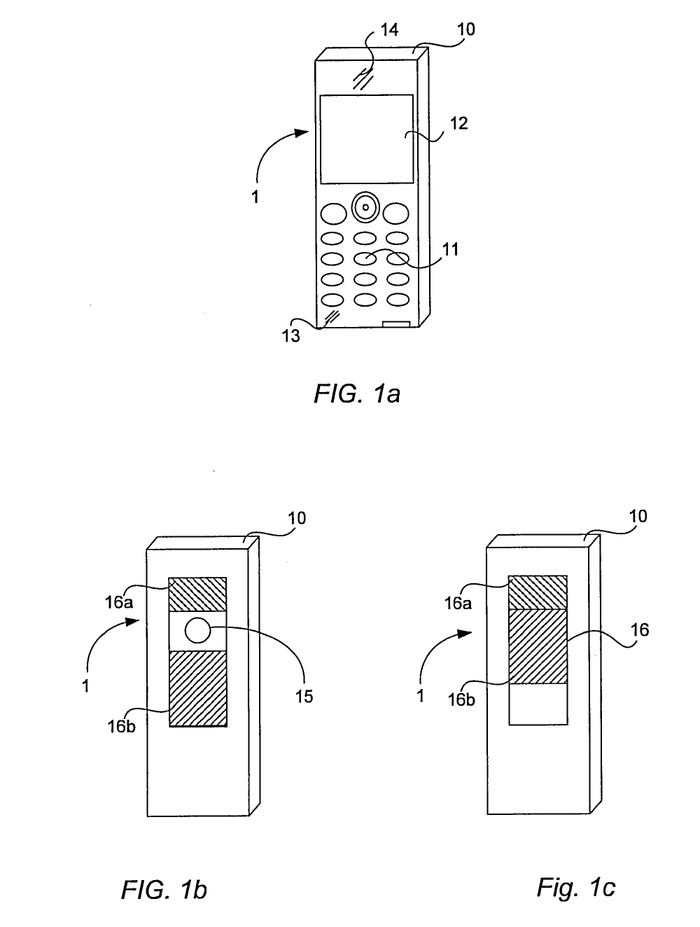

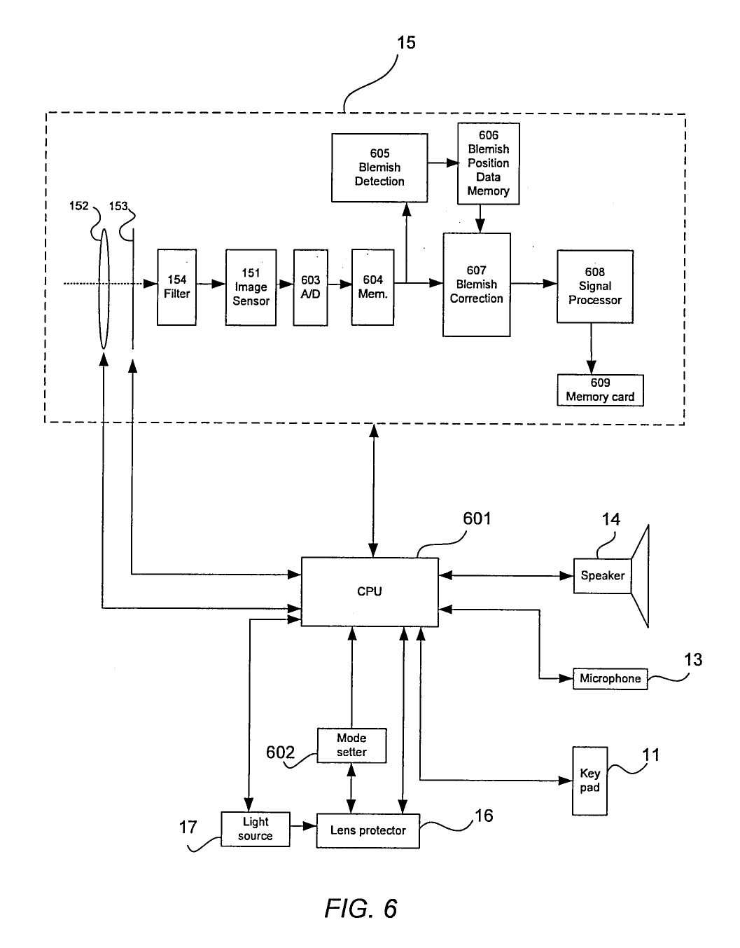

A camera device 1 configured in accordance with an embodiment of the invention is shown from two different angles in FIGS. 1a-1c, and in the form of a block diagram in FIG. 6. The camera device 1 is a portable radio communication device, or mobile phone, and comprises a support structure 10 including a housing and a chassis, arranged to support other elements of the device. A user interface includes a keypad or keyboard 11 and a display 12. Typically, the device 1 also includes an audio interface including a microphone 13 and a speaker 14, as well as radio transceiver circuitry and an antenna (not shown), even though these elements are not of importance for the embodiments of the invention and can be dispensed with if the invention is employed in an ordinary digital camera device. Normally a battery (not shown) is also included. The specific function and design of the electronic device as a communication device is as such of little importance to the invention, and will therefore not be described in any greater detail herein. It should also be noted that the list of features and elements included in the camera device 1 is in no way exhaustive. On the contrary, while the camera device 1 shown and described represents only one possible embodiment, it may well comprise further features and elements providing other functions.

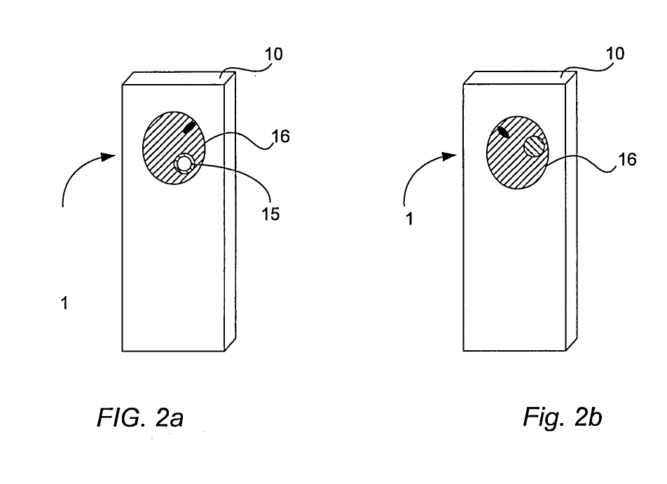

Apart from the elements outlined above, the camera device 1 also includes a digital camera 15, an aperture of which is indicated in FIG. 1b. The camera device 1 further includes a lens protector 16 for protecting the lens of the digital camera 15. The lens protector may be a lens protector 16, which operates mechanically. In the embodiment illustrated in FIGS. 1b and 1c, the lens protector is a lens protector having a first portion 16a and a second portion 16b, which are movable towards and away from each other. For example, the first and second portions 16a, 16b may be slidably moveable towards and away from each other along rails of a common frame. Such a lens protector 16 is e.g. employed in the SONY ERICSSON K750i mobile telephone available from Sony Ericsson Mobile Communications AB. The lens protector 16 may be mechanically operated to have an opened position as illustrated in FIG. 1b or a closed position as illustrated in FIG. 1c. When the lens protector 16 is in its opened position in FIG. 1b, the user of the camera device 1 may use the digital camera 15 to capture digital images of objects. When the lens protector 16 is in this open position, the user may consequently operate and interact with the camera device 1 to capture images by means of the digital camera 15. To this end, an image recording trigger, typically a push-button (not shown) or the like, is operatively connected to the digital camera 15, wherein the trigger causes the digital camera 15 to capture and record images within its field of view. On the other hand, when the lens protector 16 is in its closed position shown in FIG. 1c , the user may not use the digital camera function of the camera device 1. When the lens protector is closed, the digital camera 15 is covered by the lens protector 16. Thus, the closed lens protector 16 may act as mechanical protection for the imaging lens as well as other components of the digital camera 15. Accordingly, in its non-operative mode the digital camera 15 may be protected from scratches, particles such as dust from the surrounding environment, etc. For the sake of clarity and simplicity, most embodiments outlined herein are related to the lens protector 16, which is illustrated in FIGS. 1b and 1c. However, it should be appreciated that the lens protector 16 may take many different forms. As a mere example, in another embodiment which is illustrated in FIGS. 2a and 2b, the lens protector is a circular lens protector 16 which is mechanically rotatable from its opened position as illustrated in FIG. 2a to its closed position as illustrated in FIG. 2b. Such a lens protector 16 is e.g. employed in SONY ERICSSON P990i mobile telephone available from Sony Ericsson Mobile Communications AB.

According to some embodiments of the present invention, the lens protector 16 comprises a light-diffusing material. The light-diffusing material is suitable for illuminating the image sensor when the lens protector covers the imaging lens. The embodiments of the invention presented herein assume the use of a lens protector 16 for enabling the generation of a uniform illumination of the image sensor of the digital camera 15. This in turn may allow for the detection of blemish such as dust particles. Thus, the lens protector 16 according to some embodiments of the invention fulfils a dual purpose in that it firstly provides mechanical protection for the lens and secondly allows for the detection of blemish by enabling uniform illumination of the image sensor.

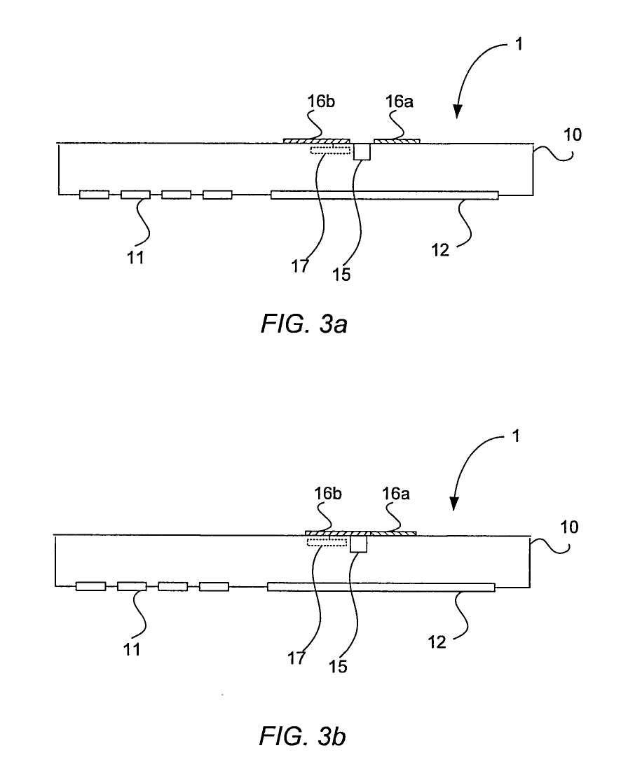

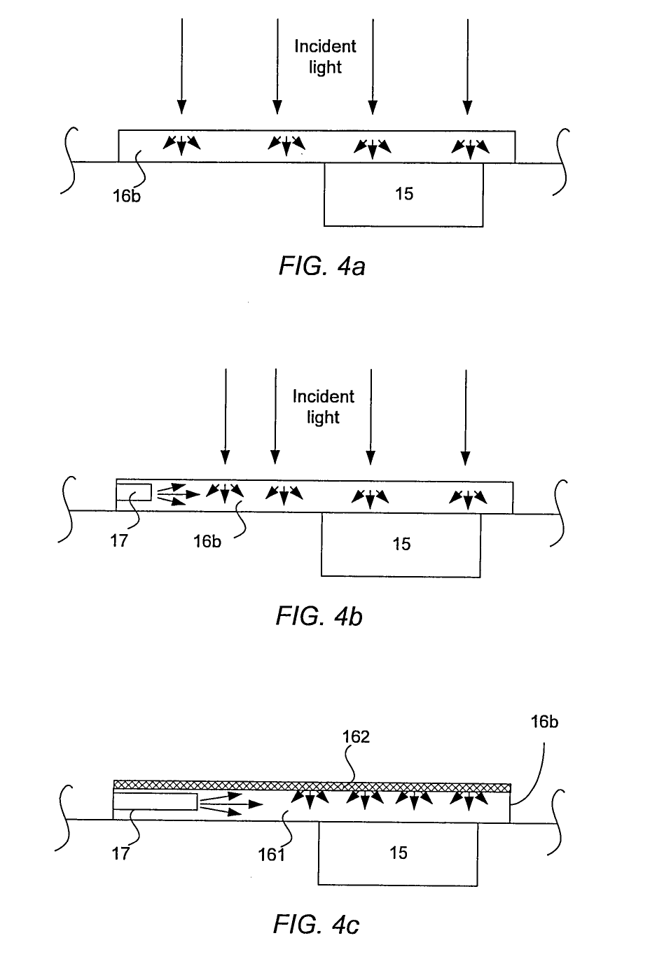

FIG. 3a schematically illustrates a cross-sectional view of an embodiment of the camera phone illustrated in FIG. 1b whereas FIG. 3b schematically illustrates a cross-sectional view of an embodiment of the camera phone illustrated in FIG. 1c. FIG. 4a illustrates a detailed cross-sectional view of one embodiment of the lens protector 16b illustrated in FIGS. 1b, 1c, 3a and 3b. In this embodiment, the entire lens protector 16b is made of a translucent material. The translucent material may allow light to pass through it diffusely. Furthermore, the translucent material may exhibit Lambertian reflectance of incident light. The lens protector 16b may e.g. be made of glass. The lens protector 16b may advantageously be made of an opal glass. Opal glass is a material including very small colorless particles embedded in a clear glass matrix. Opal glass is available in two forms commonly known as flashed opal and pot opal. The flashed opal glass is provided with a coating carried by a clear glass substrate, where the coating comprises the colorless particles. Pot opal, on the contrary, comprises diffusing particles throughout its entire thickness. As an alternative, the lens protector 16b may be made of a ground glass. Yet further, the lens protector 16b could alternatively be made of plastics.

The transmittance T of the lens protector 16b being made of the translucent material should be such that the lens protector 16b is capable of providing diffuse light towards the image sensor of the digital camera 15 when the lens protector 16b is illuminated by the incident light. The transmittance T is defined as the fraction of incident light at a specified wavelength that passes through the lens protector 16b made of translucent material:

$$T = \frac{I}{{I}_{0}} ,$$

where I₀ is the intensity of the incident light and I is the intensity of the light coming out of the lens protector 16b towards the image sensor of the digital camera 15.

The transmittance of the lens protector 16b may be given as a percentage, defined by the following formula:

$$T \% = \frac{I}{{I}_{0}} \times 100 \% .$$

In this embodiment, the transmittance of the translucent material should preferably, but not necessarily, be above 30%. The transmittance may e.g. be within the range of 10-90%, preferably as high as possible within said range.

FIG. 4b illustrates a detailed cross-sectional view of another embodiment of the lens protector 16b. The lens protector 16b of this embodiment is similar to that of FIG. 4a. A difference is that the lens protector 16b additionally comprises a light source 17, such as e.g. a Light Emitting Diode (LED) or an electroluminescent foil, being operable to illuminate the lens protector 16b. Providing a light source 17 for illuminating the lens protector 16 may be advantageous when the surrounding environment is too dark and it may be preferred to provide further luminance to the lens protector 16b from the light source 17.

FIG. 4c illustrates a detailed cross-sectional view of still another embodiment of the lens protector 16b. This lens protector 16b includes a light-guiding material 161. The light-guiding material 161 may comprise polymethyl methacrylate (PMMA). Alternatively, the light-guiding material may comprise polycarbonate (PC). Furthermore, the lens protector 16b includes a light source 17, such as a LED or an electroluminescent foil, operable to illuminate the light-guiding material. A surface of the lens protector 16b is provided with a coating 162 of light-diffusing material configured to diffusely reflect incident light (from the light source 17) when the light guiding material 161 is illuminated by means of the light source 17. For example, the coating 162 may be made of an opaque material. Alternatively, the coating 162 may comprise white paint. In particular, the white paint may include Barium Sulfate particles. As can be seen in FIG. 4, the coating 162 is positioned such that light from the light source 17 can be reflected on the coating 162 of the lens protector 16b towards the digital camera 15. This way, the image sensor of the digital camera 15 can be illuminated by the illuminated light-guiding material when the lens protector covers the imaging lens. The position of the light source 17 is only illustrative and could in practice be placed at many different positions in order to provide sufficient light. Furthermore, if the light source is an electroluminescent foil this electroluminescent foil could possibly be positioned at the location of the coating 162.

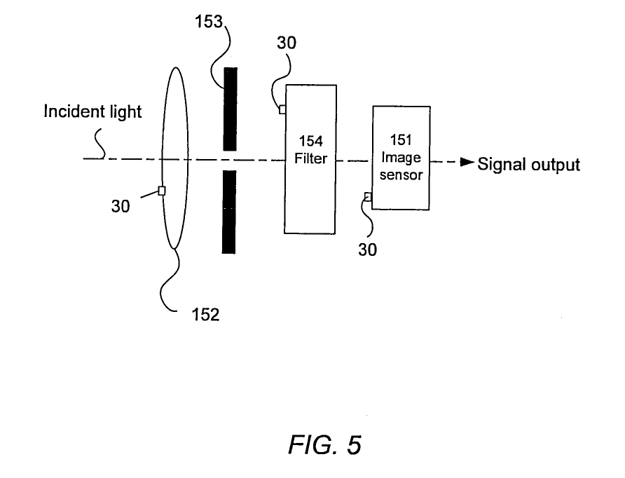

FIG. 5 illustrates the structure of an imaging section of a digital camera 15 according to an embodiment of the invention. A light image representing the image of an object is formed on a photoreceptive surface of an image sensor 151, such as an CCD-sensor or alternatively a CMOS-sensor, by an imaging lens 152. A diaphragm 153 and an optical low-pass filter 154 may be provided between the imaging lens 152 and the image sensor 151. The amount of light representing the image of the object that impinges upon the image sensor 151 may be limited by the diaphragm 153. Any noise that might be included in the incident light representing the image of the object may be removed by means of the optical low-pass filter 154. Consequently, the image sensor 151 may output a signal representing the image of the object. There are instances when one or more particles 30, such as dust, attach itself to e.g. the lens 152 of the digital camera 15. There may also be instances when such particles attaches to the surface of the optical low-pass filter 154 and/or to the photoreceptive surface of the image sensor 151. This may subsequently result in that the attached particles will appear on the image represented by the signal output from the image sensor 151. However, a target of the embodiments of the present invention is to facilitate detection or identification of blemish artifacts caused by particles 30 such as dust. Once any blemish artifacts has been detected or identified it may be possible to correct for the image of the blemish artifacts.

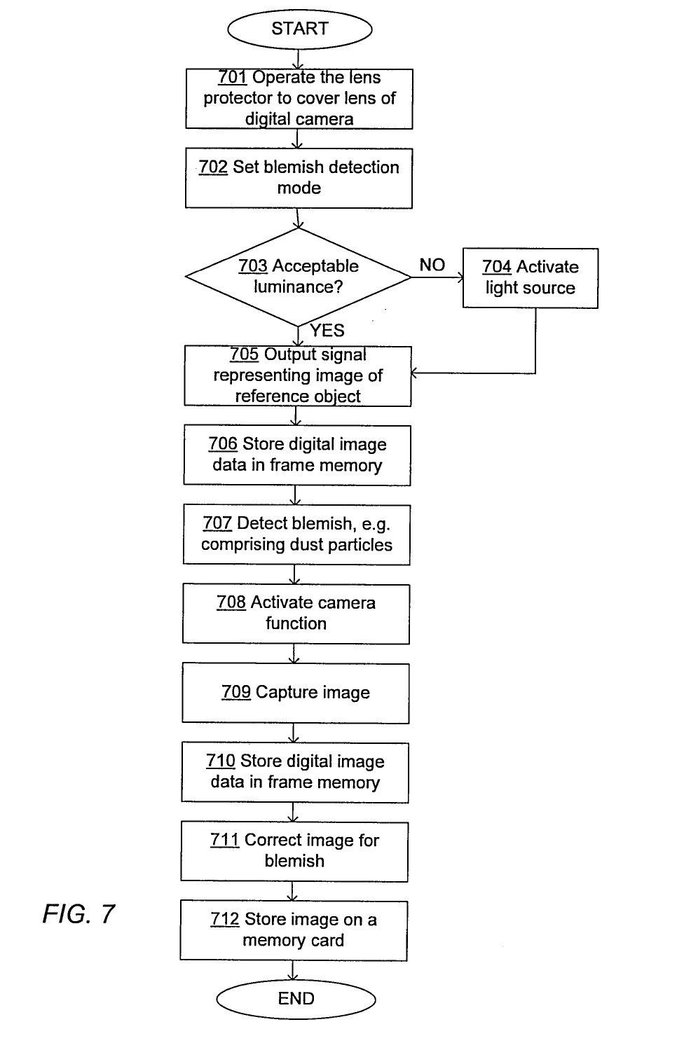

The structure and design of an embodiment of the camera device 1 is schematically shown by means of a block diagram in FIG. 6. It should be noted that the elements indicated in FIG. 6 need not necessarily be physically divided in the manner shown, and that it is the functional relationship rather than the structural arrangement that is of primary interest. Further, FIG. 7 shows a flowchart illustrating the processing executed by the camera device 1. In the following, the presented illustrative embodiment comprises a lens protector 16, wherein the entire lens protector is made of the translucent material as described with reference to FIGS. 1a, 1b, 1c, 3a, 3b and 4a. However, it should of course be appreciated that the lens protector 16 could equally possible be a lens protector 16 according to any other embodiment described herein, e.g. any of the embodiments described in connection with FIGS. 4b and 4c.

The overall operation of the camera device 1 is controlled by a controller, such as a Central Processing Unit (CPU) 601. The camera device further includes the lens protector 16 made of the translucent material for allowing incident light to pass through it diffusely. As described earlier, the lens protector 16 may be mechanically operated between two positions, one opened position and one closed position. The lens protector may be operatively connected to a mode setting device 602, which is for setting the camera device 1 in a blemish detection mode when the lens protector 16 covers the imaging lens 152. A signal indicative of the setting made by the mode setting device 602 may be input to the CPU 601. Thus, when the lens protector 16 is in the closed position, the camera device 1 may be set to a blemish detection mode. This blemish detection mode could be set automatically by the camera device 1 itself when the lens detector 16 is mechanically operated to its closed position. Alternatively, in another embodiment, the blemish detection mode could be set by the user of the camera device when the user operates and interacts with the user interface of the camera device 1.

When the user uses the camera device 1, the user may mechanically operate (step 701) the lens protector to its closed position as illustrated in FIG. 1c. When the lens protector 16 is closed such that the imaging lens 152 of the digital camera 15 is covered by the lens protector, the blemish detection mode can be set (step 702).

In order to detect blemish, it has turned out that it is generally important that the image sensor can be uniformly illuminated. When the image sensor is uniformly illuminated it is possible to detect whether an image of a reference object contains blemish such as dust particles. The presented solution is different from existing solutions in that it assumes the use of the lens protector 16 for enabling the generation of a uniform illumination of the image sensor 151. According to embodiments of the present invention, uniform illumination of the image sensor 151 is enabled by providing the lens protector, which is made of translucent material. The translucent material may allow light to pass through the lens protector 16 diffusely. In one embodiment, the camera device further comprises a light source 17, e.g. a Light Emitting Diode (LED) positioned in proximity to the lens protector 16 (see FIGS. 3a and 3b), operable to illuminate the translucent lens protector 16, such that image sensor 151 can be illuminated by the illuminated lens protector 16 when the lens protector 16 covers the imaging lens 152. Providing a light source 17 for illuminating the lens protector 16 may be advantageous when the surrounding environment is too dark for enabling a uniform illumination of the image sensor utilizing only daylight. The light source should be positioned sufficiently close to the lens protector 16 for the lens protector 16 to be sufficiently illuminated by means of the light source. For example, but not necessarily, the light source 17 could be located as illustrated in FIG. 3a (lens protector in open position) and in FIG. 3b (lens protector in closed position) when the camera device has a lens protector as shown in FIGS. 1b and 1c.

Prior to detecting any blemish it may be possible to detect (step 703) whether the lens protector 16 itself provides an acceptable luminance for uniformly illuminating the image sensor 151. If the answer is no, the light source 17 may be activated (step 704) to illuminate the translucent lens protector 16. If the answer is yes, there is no need of activating the light source 17. If so, the image sensor 151 may be sufficiently illuminated by the daylight passing through the translucent lens protector 16.

Since blemish may be detected as a luminance difference between the blemish and the surroundings of the blemish, it is in general important that the background or reference object is substantially uniform. Since the lens protector 16 according to the various embodiments of the invention can be uniformly illuminated, the lens protector 16 may act as a reference object when the camera device 1 is set in the blemish detection mode. The lens protector 16 may act as a reference object in the form of a single-color panel such as an all-white panel or, alternatively, all-grey panel.

The imaging lens 152 may be a zoom lens, the magnification of which can be changed by means of the CPU 601. The f-stop number of the diaphragm 153 may also be set by the CPU 601.

The image of the subject is formed on the photoreceptive surface of the image sensor 151 (in this illustrative example the CCD-sensor) by the imaging lens 152. If the lens protector 16 covers the digital camera 15 and the blemish detection mode is set, the reference object, i.e. the flat panel in the form of the illuminated lens protector 16, may be imaged and the image sensor 151 outputs a signal representing the image of the reference object (step 705). The signal may be input to an analog/digital-converter (A/D) 603. The A ND-converter circuit 603 converts the analog signal to digital image data. The digital image data may be temporarily stored in a memory, e.g. in a frame memory 604 (step 706). The image date is subsequently read out of the frame memory 604 and input to a blemish detector or blemish detector circuit 605. Since the reference object in the form of the illuminated lens protector 16 is being imaged, the image represented by the digital image data read out of the frame memory 604 should be a single color image such as an all-white picture or an all-grey picture. If this image, however, contains an image other than that of the color white or gray, then it will be determined that this image is the image of blemish. Furthermore, the position of the blemish is detected (step 707).

There are different ways of establishing or determining the position of the blemish. For example, address data indicative of the position of the blemish may be input to a blemish position memory 606. In this blemish position memory 606, the address data may advantageously be stored in association with the imaging conditions such as e.g. the focal length (i.e. magnification) of the imaging lens 151, the f-stop number of the diaphragm 153, etc. Since the position of the blemish may change when the focal length and/or the f-stop number change, the blemish address should preferably, but not necessarily, be stored in association with the focal length and/or the f-stop number change. It should of course be appreciated that if multiple images of blemish appear, then multiple blemish addresses should be stored in the blemish position memory 606.

Subsequently, the user may operate and interact with the camera device to activate the digital camera function (step 708) of the camera device 1. This could e.g. be done automatically when the user mechanically operates the lens protector 16 to its open position as illustrated in FIG. 1b. When the digital camera function is activated, the user then pushes the image recording trigger to cause the digital camera 15 to capture an image within its field of view. When the user pushes the image recording trigger to cause the digital camera 15 to capture an image within its field of view, the image of the object is sensed by the image sensor (step 709) in the manner as described above and a signal representing the image of the object is output. The signal is input to the A/D-converter 603. The A/D-converter converts this signal to digital image data, which is then input to the frame memory 604 in a similar manner as described earlier. The digital image data is temporarily stored in this frame memory 604 (step 710).

Subsequently, the digital image data that has been temporarily stored in the frame memory 604 is read out from the frame memory 604 and input to a blemish correction circuit 607. Then, the focal length of the imaging lens 151 and the f-stop number of the diaphragm 153 in the camera device may be detected. Address data corresponding to the detected focal length and f-stop number are read out of the blemish position memory 606 and is, then, input to the blemish correction circuit 607. The image at a position represented by blemish address data on the image obtained by image sensing is determined to be the image of blemish. Therefore, a correction is applied by the blemish correction device or blemish correction circuit 607 such that the image at this position will take on a color, which is preferably of a color same as that of the surrounding color (step 711). Consequently, the applied blemish correction will remove the image of the blemish from the image obtained in the image sensing procedure.

The image data output from the blemish correction circuit 607 may be input to a signal processor 608 for correcting the signal even further, if any further signal processing is needed. The corrected signal is subsequently output from the signal processor 608. Image data that is output from the signal processor 608 can then be input (step 712) to a memory card 609. Since image data from which a blemish image has been removed is stored on the memory card 609, the image represented by the stored image data can be rendered as an image which is free from the appearance of blemish artifacts.

In the prior art, the camera device manufacturers are focusing and preoccupied with the improvement of their own blemish detection and correction techniques. However, until now there has been no easy and quick post-production blemish detection of camera devices, which have already been shipped from the camera device manufacturers. Some embodiments of the present invention thus fulfill a relatively long-felt need among customers of camera devices in that these embodiments of the present invention provide a quick, easy and cheap way of detecting blemish. The presented solution according to some embodiments of the invention are different from existing solutions in that they assume the use of a lens protector, which enables for a uniform illumination of the image sensor of the digital camera. This in turn may allow for the detection of blemish such as dust particles. Thus, the lens protector according to some embodiments of the invention fulfils a dual purpose in that it 1) provides mechanical protection for the lens and 2) allow for the detection of blemish by enabling uniform illumination of the image sensor. Thus, a digital camera device according to some embodiments of the present invention is particularly suitable if the camera device is already intended to include a lens protector for any other purpose, e.g. for mechanical protection of the lens of the camera device. It is an advantage with some embodiments of the invention that they allow an easy and quick way of blemish detection and correction which can be performed by the users of the camera devices themselves. Thus, the customers of the camera devices may themselves detect and correct blemish before an image is captured by the digital camera. In turn, this may allow for more blemishes being accepted during the production of the camera devices and, hence, the total price of the camera devices could as a consequence be reduced.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The foregoing description of implementations consistent with principles of the present invention provides illustration and description, but is not intended to be exhaustive or to limit the invention to the precise form disclosed. Different method steps than those described above, performing the method by hardware or software or a combination of both hardware and software may be provided within the scope of the invention. The different features and method steps of the invention can be combined in other combinations than those described. Thus, the invention should not be construed as being limited to the particular embodiments discussed above. Rather, the above-described embodiments should be regarded as illustrative rather than restrictive, and it should be appreciated that variations may be made in those embodiments by persons skilled in the art without departing from the scope of the present invention as defined by the appended claims.

1. A digital camera device having an imaging device for sensing the image of a subject using an image sensor and outputting image data representing the image of the subject, and an imaging lens for forming the image of the subject on a photoreceptive surface of the image sensor, the digital camera comprising:
a lens protector configured to cover the imaging lens, wherein the lens protector comprises a light-diffusing material for illuminating the image sensor when the lens protector covers the imaging lens; and
a blemish position detector operative when the lens protector covers the imaging lens, and when the image sensor is illuminated the blemish position detector is further configured to detect the position of blemish on an image, which is represented by image data output from the imaging device, on the basis of image data output from the imaging device.

2. The digital camera device of claim 1, wherein the light-diffusing material is a translucent material.

3. The digital camera device of claim 2, wherein the lens protector comprises a surface with a coating made of the translucent material.

4. The digital camera device of claim 2, wherein the entire lens protector is made of the translucent material.

5. The digital camera device of claim 2, wherein the transmittance of the light-diffusing material is within the range of 10-90%.

6. The digital camera device of claim 2, wherein the light-diffusing material exhibits Lambertian reflectance of incident light.

7. The digital camera device of claim 2, wherein the light-diffusing material is glass.

8. The digital camera device of claim 7, wherein the glass is opal glass or ground glass.

9. The digital camera device of claim 2, wherein the light-diffusing material is plastics.

10. The digital camera device of claim 2, the lens protector further comprising a light source operable to illuminate the lens protector, such that image sensor can be illuminated by the illuminated lens protector when the lens protector covers the imaging lens.

11. The digital camera device of claim 10, wherein the light source is a Light Emitting Diode positioned within the lens protector.

12. The digital camera device of claim 10, wherein the light source is an electroluminescent foil positioned within the lens protector.

13. The digital camera device of claim 1, wherein the lens protector comprises a light-guiding material, a light source operable to illuminate the light-guiding material, and a surface with a coating made of the light-diffusing material, wherein the coating of light-diffusing material is configured to diffusely reflect incident light when the light guiding material is illuminated and wherein said coating is further positioned such that the image sensor can be illuminated by the illuminated light-guiding material when the lens protector covers the imaging lens.

14. The digital camera of claim 13, wherein the light-guiding material comprises polymethyl methacrylate (PMMA).

15. The digital camera of claim 13, wherein the light-guiding material comprises polycarbonate (PC).

16. The digital camera of claim 13, wherein said coating is made of an opaque material.

17. The digital camera of claim 13, wherein said coating is a white paint.

18. The digital camera of claim 17, wherein said coating comprises Barium Sulfate particles.

19. The digital camera of claim 13, wherein the light source is a Light Emitting Diode positioned within the lens protector.

20. The digital camera of claim 13, wherein the light source is an electroluminescent foil positioned within the lens protector.

21. The digital camera device of claim 1, further comprising a light source operable to illuminate the lens protector, such that image sensor can be illuminated by the illuminated lens protector when the lens protector covers the imaging lens.

22. The digital camera device of claim 21, wherein the light source is a Light Emitting Diode positioned in proximity to the lens protector.

23. The digital camera device of claim 1, further comprising:
a storage device, configured to store the blemish position detected by said blemish position detector; and
a correction device operative when the lens protector covers the imaging lens, the correction device being configured to correct for the image of the blemish, at the position stored in said storing device.

24. The digital camera device of claim 1, wherein the blemish comprises dust particles.

25. The digital camera device of claim 1, the digital camera device being incorporated in a mobile telephone.

26. A method of controlling the operation of a digital camera device having an imaging device for sensing the image of a subject using an image sensor and outputting image data representing the image of the subject, an imaging lens for forming the image of the subject on a photoreceptive surface of the image sensor, and a lens protector configured to cover the imaging lens, wherein the lens protector comprises a light-diffusing material for illuminating the image sensor when the lens protector covers the imaging lens, the method comprising the steps of:
operating the lens protector to cover the imaging lens; and
detecting the position of blemish on an image, which is represented by image data output from the imaging device, on the basis of image data output from the imaging device.

27. The method of claim 26, further comprising the step of:
illuminating the lens protector, such that image sensor can be illuminated when the illuminated lens protector covers the imaging lens.

28. The method of claim 27, further comprising the steps of:
storing the detected blemish position; and
correcting for the image of the blemish, at the stored position.

29. The method of claim 26, wherein the blemish comprises dust particles.

30. A computer program product comprising computer program code means for controlling the operation of a digital camera device when said computer program code means is executed by means of a processor of the digital camera device, the digital camera having an imaging device for sensing the image of a subject using an image sensor and outputting image data representing the image of the subject, an imaging lens for forming the image of the subject on a photoreceptive surface of the image sensor, and a lens protector configured to cover the imaging lens, wherein the lens protector comprises a light-diffusing material for illuminating the image sensor when the lens protector covers the imaging lens; wherein the computer program code means comprises:
code means for operating the lens protector to cover the imaging lens; and
code means for detecting the position of blemish on an image, which is represented by image data output from the imaging device, on the basis of image data output from the imaging device.

31. The computer program product of claim 30, further comprising:
code means for illuminating the lens protector, such that image sensor can be illuminated when the illuminated lens protector covers the imaging lens.

32. The computer program product of claim 31, further comprising:
code means for storing the detected blemish position; and
code means for correcting for the image of the blemish, at the stored position.

33. The computer program product of claim 30, wherein the computer program product is embodied on a computer readable medium.

34. The computer program product of claim 30, wherein the digital camera device is incorporated in a mobile telephone.
